(19) United States
(12) Patent Application Publication
(10) Pub. No.: US 2025/0083004 A1
(43) Pub. Date: Mar. 13, 2025

(54) SYSTEMS AND METHODS FOR CALIBRATING A MOBILE DEVICE FOR USE IN GREEN READING

(71) Applicant: GOLFTEC ENTERPRISES LLC, Englewood, CO (US)

(72) Inventors: Nick CLEARWATER, Englewood, CO (US); Terry SPENCE, Englewood, CO (US)

(21) Appl. No.: 18/466,200

(22) Filed: Sep. 13, 2023

Related U.S. Application Data
(63) Continuation of application No. 18/466,158, filed on Sep. 13, 2023.

(51) Int. Cl. A63B 57/00; A63B 71/06

(52) U.S. Cl. CPC A63B 57/00; A63B 71/0622; A63B 2220/40; A63B 2220/70

(57) ABSTRACT

Systems and methods are provided for calibration of a mobile device for green reading. Preferred embodiments include performing auto-leveling of the mobile device to accommodate for protruding features, and then placing the mobile device on a substantially flat surface. A first set of accelerometer data is collected of the mobile device and then mobile device is rotated in a preferred direction to collect a second set of accelerometer data of the mobile device. The collected first and second sets of accelerometer data are converted to pitch calibrations and roll calibrations, and averages for the pitch and roll calibrations are computed and saved on the mobile device. After the mobile device has been calibrated, it can be used to read a putting green.

### CROSS-REFERENCES TO RELATED APPLICATIONS

This application is a continuation of copending U.S. patent application Ser. No. 18/466,158 filed Sep. 13, 2023, which is incorporated herein by reference in its entirety.

### TECHNICAL FIELD

The subject matter described herein relates to a systems, methods, and devices for computing characteristics of a golf putt, and more particularly to calibrating a mobile device for the use of reading a putting green.

### BACKGROUND

In golf, whether playing professionally or for fun, putting is specific skill that golfers must master in order to improve their scores. Practicing and improving putting not only involves perfecting a golfer's golf stroke, but it also involves how to properly read a green. Properly reading a green requires a golfer to determine the proper starting direction of a put and the proper pace to hit the ball to give the golfer the best chance of making a particular putt.

A proper green read (start direction and pace) is largely determined by the length of the putt and the conditions of the green, i.e. the slope of the green, the amount of slope, the direction of the slope (collectively the “break”), and the speed of the green. The green speed can be measured by the amount of friction that affects a golf ball in motion. Factors such as the moisture content of the green, time of day, type of grass, length of grass, etc., can impact the amount of friction the green surface has on a golf ball. Because bole locations and green speed change from day to day, properly reading greens can be a difficult task to master.

Pace and break are interrelated. For example, if the pace is too fast, the break will be minimized. If the pace is too slow, the break will be accentuated. Consequently, a golfer has to correctly calibrate pace and break in order to properly read a green.

Because perfecting putting is complex, golfers routinely turn to practice aids to help them train. Many devices, software applications, and visual aids are currently available in the art. However, none of these training aids provide a golfer with a proper green read and a tangible swing deviation that identifies a proper pace and break. The present invention, therefore, provides improvements in the art by calculating a proper green read and disclosing to a golfer the proper swing when combined with that green read to make a putt.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a putting parameter determination system. The putting parameter determination system includes systems and methods of calculating an optimal putting line and putting stroke on a golf putting green. Preferred embodiments include receiving user input data at a processor, where the user input data includes at least a putt distance calibration, a green friction calibration and a targeted distance past the cup calibration. Next, a magnitude of break calibration of the putting green is calculated, where the magnitude of break calibration includes an averaged pitch and roll calculation of the putting green. A velocity calibration is also calculated, where the velocity calibration comprises an averaged optimal initial velocity calculation of a putt. The user input data, the magnitude of break calibration and the velocity calibration are then combined to create green reading data. The green reading data is used to create user output data that is displayed to a user on a user interface. In preferred embodiments, the user output data comprises the optimal putting line for a user on the golf putting green and an optimal putting stroke. The optimal putting stroke comprises a numerical deviation of a backswing of a golfer based at least in part on the golfer's normal backswing and the green reading data.

In some preferred embodiments, the pitch and roll calculation and the optimal initial velocity are calculated by placing a mobile device on the putting green at a location in between a golf ball and a golf cup location. The mobile device collects a plurality of velocity and pitch and roll data of the putting green. In some preferred embodiments, the averaged pitch and roll calculation and the optimal initial velocity calculation is averaged by taking at least 100 readings, although more or less may also be calculated. In some preferred embodiments, the location of the mobile device when calculating the averaged pitch and roll calculation and the optimal initial velocity calculation is approximately ⅔rds the distance to the golf cup location from the golf ball location. This positioning allows for optimal data collection in some preferred embodiments. In preferred embodiments, the numerical deviation of the backswing of the golfer is displayed to a user on the user interface by comparing the golfer's normal putting backswing to the numerical deviation of the backswing based at least in part on the green reading data.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the putting parameter determination system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is schematic, diagrammatic representation, in block diagram form, of an example putting parameter determination system, in accordance with at least one embodiment of the present disclosure.

FIG. 2 is a schematic, diagrammatic representation of an example putting parameter determination system, in accordance with at least one embodiment of the present disclosure.

FIG. 3 is a schematic, diagrammatic representation of the forces acting on a golf ball rolling on a level putting green, in accordance with at least one embodiment of the present disclosure.

FIG. 4 is a schematic, diagrammatic top view of a golf ball launched by a golf club such as a putter, in accordance with at least one embodiment of the present disclosure.

FIG. 5A describes a method of a calibration process, in accordance with at least one embodiment of the present disclosure.

FIG. 5B is a schematic, diagrammatic representation of auto-leveling of a mobile device, in accordance with at least one embodiment of the present disclosure.

FIG. 5C is a schematic, diagrammatic representation of calibrating a mobile device for green reading, in accordance with at least one embodiment of the present disclosure.

FIG. 5D is a schematic, diagrammatic representation of calibrating a mobile device for green reading, in accordance with at least one embodiment of the present disclosure.

FIG. 6 is a schematic, diagrammatic representation of a putting green slope measurement process, in accordance with at least one embodiment of the present disclosure.

FIG. 7 is a schematic, diagrammatic representation of a putting green measurement process, in accordance with at least one embodiment of the present disclosure.

FIG. 8A is a schematic, diagrammatic representation of a golf ball approaching a cup, in accordance with at least one embodiment of the present disclosure.

FIG. 8B is a schematic, diagrammatic representation of a golf ball approaching a cup, in accordance with at least one embodiment of the present disclosure.

FIG. 8C is a schematic, diagrammatic representation of a golf ball approaching a cup, in accordance with at least one embodiment of the present disclosure.

FIG. 8D is a schematic, diagrammatic representation of a golf ball approaching a cup, in accordance with at least one embodiment of the present disclosure.

FIG. 9 shows a flow diagram of an example putting parameter determination method, in accordance with at least one embodiment of the present disclosure.

FIG. 10A shows various putting paths based various putting greens, in accordance with at least one embodiment of the present disclosure.

FIG. 10B shows various putting paths based various putting greens, in accordance with at least one embodiment of the present disclosure.

FIG. 10C shows various putting paths based various putting greens, in accordance with at least one embodiment of the present disclosure.

FIG. 11 is a schematic diagram of the system logic, according to embodiments of the present disclosure.

FIG. 12 is a schematic diagram of a processor circuit, according to embodiments of the present disclosure.

### DETAILED DESCRIPTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of installing, assembling and operating the system is described in detail according to the preferred embodiment, without attempting to describe all of the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

In accordance with at least one embodiment of the present disclosure, a putting parameter determination system is provided that allows both professional and amateur golfers technology to practice putting. Preferred embodiments start with allowing a user to input certain pieces of information (user input data); a putt distance, a green friction and a targeted distance past the cup. In some preferred embodiments, the green friction (i.e., how fast the green is based upon stimpmeter reading) will automatically be integrated with third-party data and information to make this user input easier for a user to operate.

Next, a magnitude of break calibration of the putting green is calculated, wherein the magnitude of break calibration includes an averaged pitch and roll calculation of the putting green (the green slope as measured left/right and front/back). The optimal initial velocity of a putt is determined, based at least in part on the putt distance and the targeted distance past the cup. The user input data, the magnitude of break and the velocity are then combined at the processor to create green reading data, which is displayed to a user.

In some preferred embodiments, the putt distance is entered by a user after a user paces off the distance of a putt. In other embodiments, the putt distance is collected by using a camera functionality on a user's mobile device or smartphone. Other systems and methods of calculating putt distance could also be used. In some preferred embodiments, a green speed calculation is entered by a user, and for simplicity, the user chooses from either a slow, medium, or fast green speed option.

In preferred embodiments, a distance past cup input is required in inches, with 12 inches past the cup being set as the default. However, a user may change the desired distance past the cup from 0-20 inches.

For the purpose of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

The putting parameter determination system may be implemented as a process viewable on a display, and operated by a control process executing on a processor that accepts user inputs from a virtual keyboard, virtual mouse, or touchscreen interface, and that is in communication with one or more sensors. In that regard, the control process performs certain specific operations in response to different inputs or selections made at different times. Outputs of the putting parameter determination system may be printed, shown on a display, read aloud as audio instructions, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only and should not be considered to limit the scope of the putting parameter determination system. Certain features may be added, removed, or modified without departing from the spirit of the claimed subject matter.

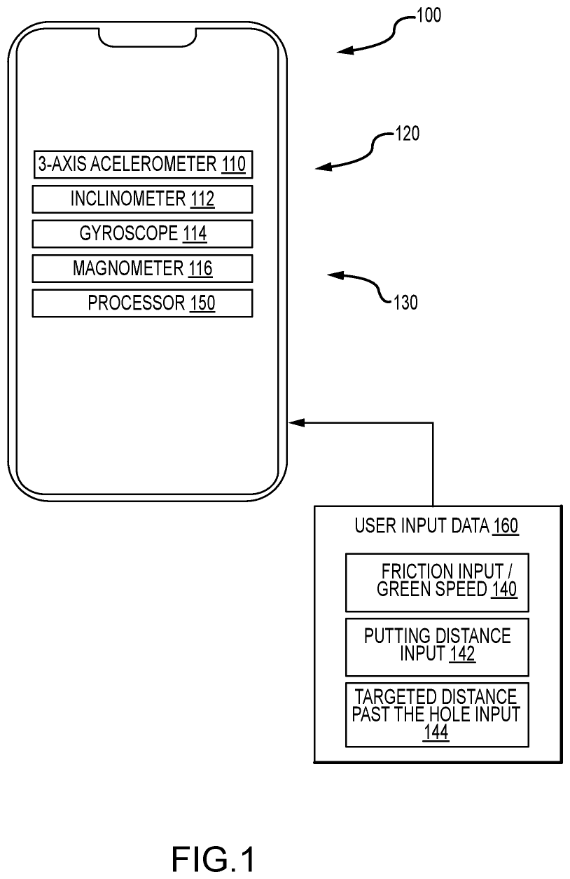

In accordance with at least one embodiment of the present disclosure, FIG. 1 is schematic, diagrammatic representation, in block diagram form, of an example putting parameter determination system 100, in accordance with at least one embodiment of the present disclosure.

The putting parameter determination system 100 may for example include input data sources such as a 3-axis accelerometer 110, an inclinometer 112, a gyroscope 114 (e.g., a 3-axis gyroscope), a magnetometer 116, mobile device camera 120, and a user interface 130. User inputs may include a friction coefficient user input/green speed 140, a putting distance user input 142 (e.g., a distance between the ball and the cup), and a “targeted distance past the cup” user input 144 (collectively user input data 160).

These input data sources may for example be provided through a mobile phone 120 or other mobile device as described below.

The input data is received by a processor 150, which generates a user input 160.

It is noted that block diagrams are provided herein for exemplary purposes; a person of ordinary skill in the art will recognize myriad variations that nonetheless fall within the scope of the present disclosure. For example, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Before continuing, it should be noted that the examples described above are provided for purposes of illustration and are not intended to be limiting. Other devices and/or device configurations may be utilized to carry out the operations described herein.

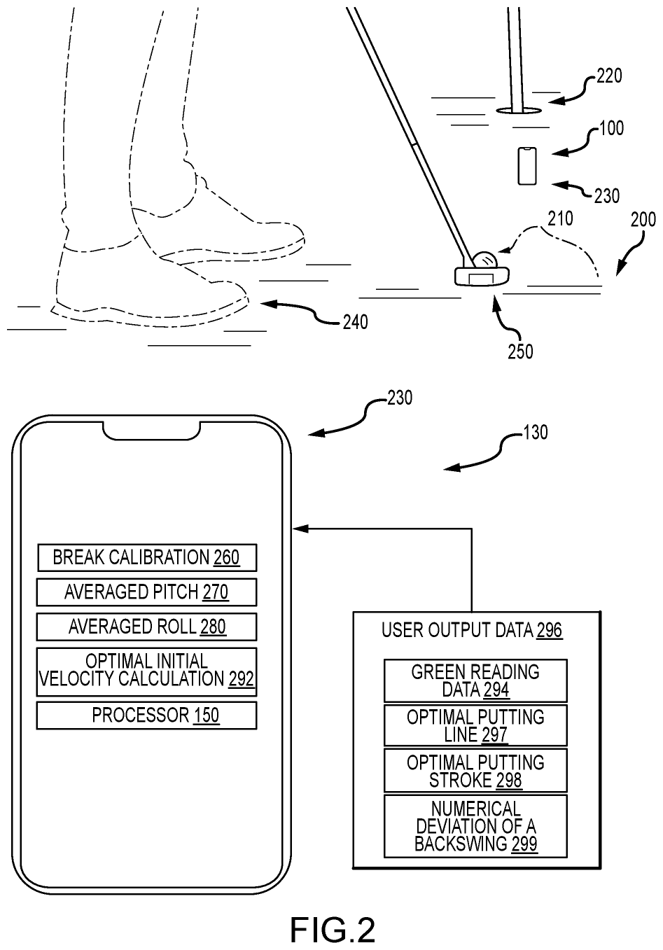

FIG. 2 is a schematic, diagrammatic representation of an example putting parameter determination system 100, in accordance with at least one embodiment of the present disclosure. Accordingly, system 100, putting green 200, ball 210, cup 220, phone 230 sitting on the putting green, golfer 240 standing with putter 250 are disclosed. In some preferred embodiments, the golfer 240 places the phone 230 on the green 200 between ball 210 and cup 220, screen side up and approximately ⅔rds of the distance towards the cup 220. The phone 230, using the internal 3-axis accelerometer 110, inclinometer 112, gyroscope 114 (e.g., a 3-axis gyroscope), and/or magnetometer 116, calculates a magnitude of break calibration 260 of the putting green 200, where the magnitude of break calibration 260 includes an averaged pitch 270 and roll 280 calculation of the putting green 200. A velocity calibration 290 is also calculated, where the velocity calibration 290 comprises an averaged optimal initial velocity calculation 292 of a putt. The user input data 160, the magnitude of break calibration 260 and the velocity calibration 290 are then combined at the processor 150 to create green reading data 294. The green reading data 294 is used to create user output data 296 that is displayed to a golfer 240 on a user interface 130. In preferred embodiments, the user output data 296 comprises the optimal putting line 297 for a user on the golf putting green and an optimal putting stroke 298. The optimal putting stroke comprises a numerical deviation of a backswing of a golfer 299 based at least in part on the golfer's normal backswing and the green reading data 294.

For example, in some preferred embodiments, a golfer 240 may open up a green reading app on the golfer's smartphone 230. The golfer 240 would enter the distance of the putt from the ball 210 to the cup 220. Golfer 240 could collect this data by physically pacing the distance or by collecting it from variety of other means, such as, for example, from phone camera 120. The golfer would then enter a green speed, i.e. green slow=8 stimp, medium=10 stimp, fast=12 stimp) and a distance past cup if the putt were to miss from between 0 to 20 inches, with 12 inches being the default.

In preferred embodiments, a user collects data from a putt by placing a user's smart phone on a putting green in between the ball and the cup, wherein ideal placement is roughly ⅔rds distance to the cup from the ball. In some embodiments, placing the smart phone in multiple locations in between the ball and cup may provide for more accurate data collection. A ⅔rds distance to the cup from the ball provides more accurate information because, at roughly this distance, the ball will start to move at a slower pace, possibly enhancing the amount of break as the ball approaches the cup. For example, collecting data from a point that is closer to the ball and farther from the cup would not be as accurate because the ball is moving faster when it is just struck by the putter and will not break as much.

In preferred embodiments, a user, via a green reading mobile app, places the phone on the green and hits an aim button on the app. The phone placed on the putting green uses the phone's 3-axis accelerometer, inclinometer, gyroscope, and/or magnetometer to calculate the pitch and roll of the putting green. In some preferred embodiments, a sample of 100 readings of the x, y, z coordinates are collected and time-averaged to establish a baseline for pitch and roll.

In preferred embodiments, the plurality of green readings is then incorporated into equations of motion, which will identify a preferred ball trajectory to the cup as well as an initial speed for the ball to be struck by the club in order for the ball to go into the cup (pace and break). Other data that may be translated to a user is the deviation of backswing from normal backswing.

In preferred embodiments, the pace and break of the putt are determined numerically by starting with an educated guess in meters per second (mps) aimed directly at the cup. The initial speed of each putt is computed in the following manner:
Putting on a level surface (pitch=0, roll=0) or across a tilted green with pitch=0, roll is non-zero. Starting speed is

$${( ( \frac{10}{7} ) {ρ}_{g} gy )}^{1 / 2}$$

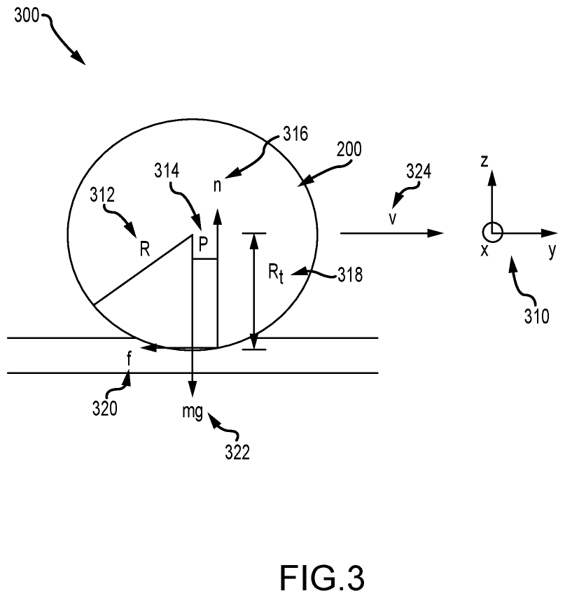

ρ_{g}=R/ρ, where R=radius of golf ball; ρ=position of the equivalent single contact point on a golf ball, the perpendicular distance between the normal component of the contact force and the center of mass of the golf ball. (See FIG. 3); g is the earth's gravitational acceleration; y is the desired putt length.
Putting straight uphill. Starting speed is:

$${( ( \frac{10}{7} ) ( {ρ}_{g} cos φ + sin φ ) gy )}^{1 / 2}$$

φ represents the pitch of the green (i.e., the amount of slope)
Putting straight downhill. Starting speed is set at 0.2 mps.
The final speed of each successfully holed putt varies depending on the slope of the green and speed of the ball as it reaches the cup's rim. The final speeds of each putt are as follows. Putting on a level surface or across a tilted green with pitch=0, roll is non-zero.

$$0 < {υ}_{f} < 1.63 m / s$$

Putting straight uphill:

$$0 < {υ}_{f} < 1.71 m / s$$

Putting straight downhill:

$$0 < {υ}_{f} < 1.56 m / s$$

FIG. 3 is a schematic, diagrammatic representation of the forces 300 acting on a golf ball 210 rolling on a level putting green 200, in accordance with at least one embodiment of the present disclosure.

Visible are x, y, and z axes showing a coordinate system 310 within which the ball 210 is rolling.

R=radius of golf ball 312.

P=position of the equivalent single contact point on a golf ball, the perpendicular distance between the normal component of the contact force and the center of mass of the golf ball 314.

n=normal 316.

Rₜ 318=the perpendicular distance between the tangential component of the contact force and the center of mass of the golf ball. Rₜ will always be less than or equal to the radius of the ball.

f=tangential component of retarding force 320.

mg=mass times gravitational acceleration, aka. Weight 322.

v=velocity 324.

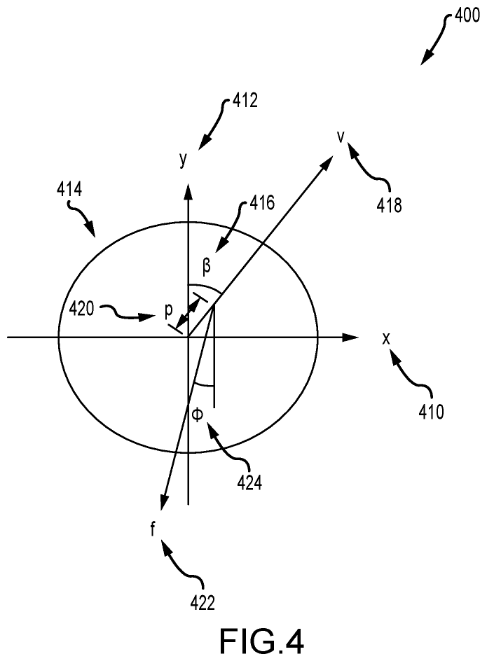

FIG. 4 is a schematic, diagrammatic top view of a golf ball 210 launched by a golf

club such as a putter, in accordance with at least one embodiment of the present disclosure 400.

Visible are x 410 and y 412 axes showing the coordinate system 414 within which the ball 210 is rolling.

β=starting angle of rolling ball 416.

v=speed of ball 418.

ρ_{g}=R/ρ 420.

f=the tangential component of the retarding force 422.

φ=the direction of f 424.

The value of ρ_{g} would be expected to be primarily determined by the firmness of

the green, as well as the condition of the grass surface. In golf, one often refers to the speed of the green as follows:
A fast green is one where the ball rolls a relatively long distance before coming to rest.
A slow green is one where the ball comes to a stop relatively quickly.
   The speed of a green will be directly related to the deceleration of the golf ball and will be a measure of the value of ρ_{g}.

The speed of a green is measured by a device known as a stimpmeter, which is essentially a ramp, exactly one yard long, with a slot running down the center to allow a golf ball to roll down the length of the ramp. There are two notches on the stimpmeter, one 30 inches from the end resting on the ground, also known as the 1× notch, and another 14 inches from the end. After placing a ball at the 30-inch notch, the stimpmeter is tilted until the point at which the golf ball rolls down the ramp and across a flat section of the green. If no suitable flat areas can be found (because the green is sloping too much), the 2× position is used, doubling the rollout distance to determine the actual stimp reading. For consistency's sake (using the 30-inch notch), the ball leaves the end of the stimpmeter at approximately 1.83 mps. If a ball rolls out twelve feet, the stimpmeter reading would be “12” and one would say this green is fast. On the other hand, were the ball to roll only six feet (stimp=6) we would call this a very slow green. In preferred embodiments, the initial velocity of the putt is increased by 0.01 mps until the desired putt length plus distance past is reached.

In preferred embodiments, the phone 230 is then placed roughly ⅔rds distance to the cup 220 on the putting line from the ball 210 to the cup 220. The golfer then hits an aim button on the app. In some embodiments, the phone 230 must “point” to the cup 220, with the top of the device being closest to the cup 220. In other embodiments (e.g., utilizing Augmented Reality), the phone 220 can be oriented without “pointing” to the cup 220. Within the app, while using the latitude of the device location, gravitational acceleration is computed, as well as an accelerometer moving average. After 100 samples are collected, a moving average (mean) value of (x/y/z) is converted to the roll 270 and pitch 280 of the putting green 200. The roll and pitch values saved from the setup process are subtracted from the collected roll 270 and pitch 280 of the putting green 200 to get corrected reading.

Subsequently, a velocity calibration 290 is determined by numerically progressing through a series of starting ball velocities and directions until the ball is successfully holed.

As discussed in the white paper “The physics of putting,” by A. R. Penner, both the ball and the surface on which it rolls become slightly deformed, thus providing a retarding force that acts on the ball. The force due to the deformed surface will be distributed over the contact area and will be equivalent to a single force and a couple acting on the ball. Note that a couple, or couple moment, consists of two equal, but opposite forces acting to produce rotation (e.g., the forces that two hands apply to turn a steering wheel whenever the hands grip the wheel on opposite sides). In this instance, the leading edge of the rolling ball is pushing against a deformed ground, which in turn is exerting a retarding force at the bottom of the ball-ground contact area. In other words, this force and couple are equivalent to a single force acting at the point on the ball's surface where the resulting moment is equal to that of the couple.

This equivalent force can be resolved into a component, n, normal to the surface and a component, f, tangential to the surface. In addition, these two forces act on a point towards the leading side of a rolling golf ball, at a distance, p, from the bottommost point of the ball/ground contact area. That is, the ground/ball interface directly below the center of gravity of the ball.

In preferred embodiments, the process begins with a numerical analysis by “hitting” a putt with an initial ball velocity as described earlier.

A ball propagation loop is completed by the following steps:
1. “Hit” ball on a line directly at the cup (up the y-axis in FIG. 4). Beta=0, where angle Beta represents the target line relative to the cup. Said another way, it represents the initial direction of ball motion.
2. Compute direction of contact force, ϕ. Angle theta (Θ) represents the roll angle of the device and psi (φ) represents pitch. Rho (ρ_{g}) represents the rolling friction. We ignore any initial sliding of the golf ball when struck (static friction).

$$tan ϕ = \frac{{ρ}_{g} cos θ cos φ sin β - {I}_{b} sin θ}{{ρ}_{g} cos θ cos φ cos β - {I}_{b} cos θsin φ}$$

3. Compute magnitude of contact force, f

$$f = \frac{{ρ}_{g} cos θ cos φ cos β - {I}_{b} cos θ sin φ}{( 1 + {I}_{b} ) cos ϕ} m g$$

4. Compute acceleration in x and y directions, with y axis being line between ball and cup.

$${ma}_{x} = - m g sin θ - f sin ϕ$$

$${ma}_{y} = - m g cos θ sin φ - f cos ϕ$$

5. Using our initial velocity and the acceleration values just determined, compute the time it takes for ball to stop (time_to_stop=initial_velocity/acceleration).
6. Set the stopping condition to 1.5 cm/second.
7. Propagate the ball over the duration of the stop time calculated above.
8. “hitting” a putt with an initial ball velocity as described earlier.

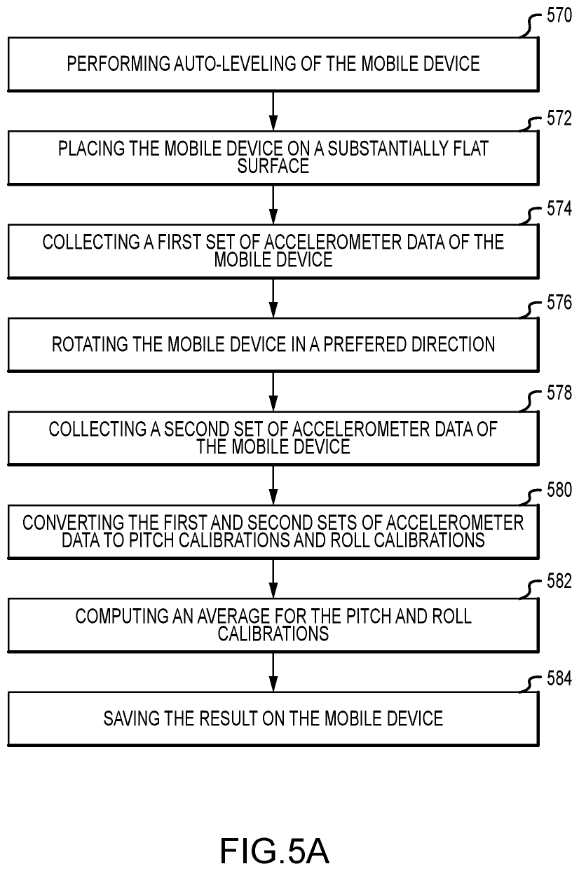

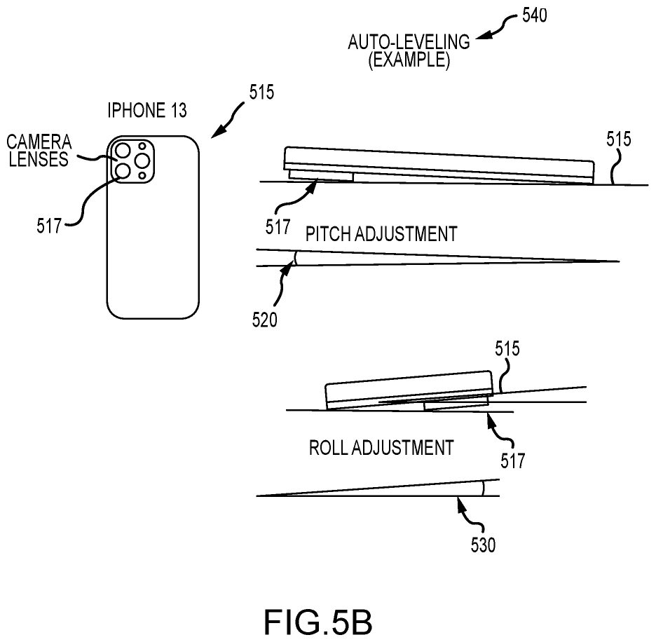

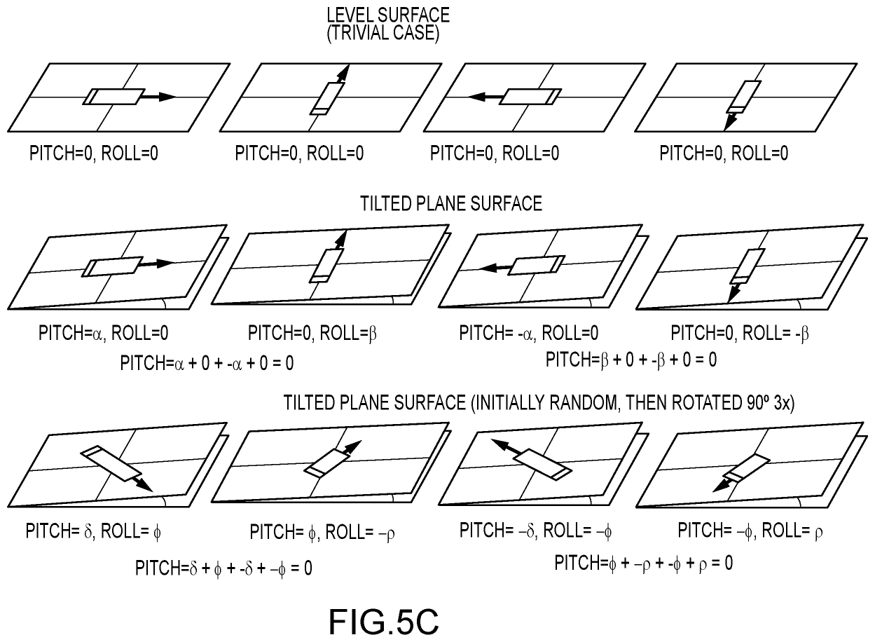

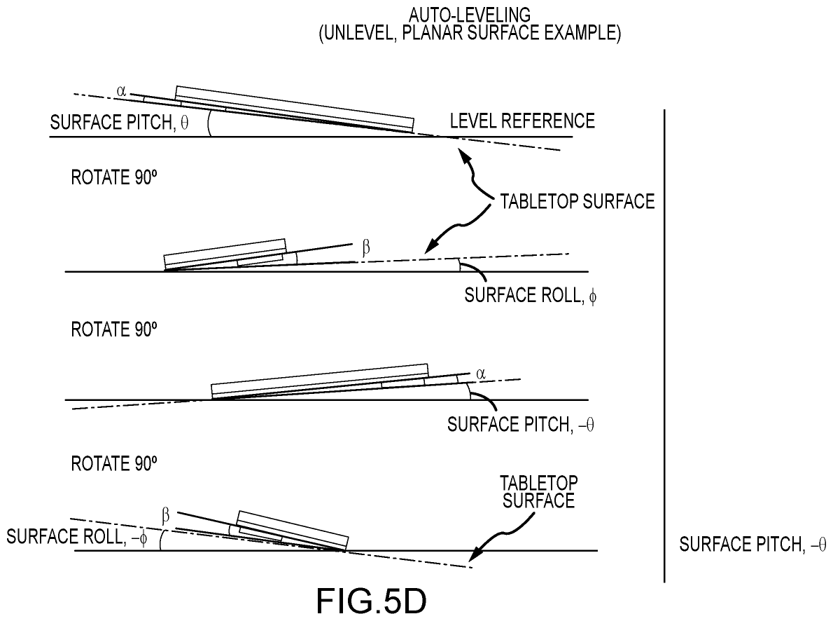

FIGS. 5A-5D describe a calibration process 500, in accordance with at least one embodiment of the present disclosure. The calibration process 500 may for example involve placing the mobile device 230 on a flat surface 510 to align the mobile device 230 with gravity, in order to facilitate calibration of the 3-axis accelerometer 110.

Properly calibrating a user's smart phone or mobile device is also necessary to obtain correct green reading data. With the advent of sophisticated camera lenses and cases, most devices will not lie flush, even on a flat surface. To counter the effects of an uneven lie, the device must first be calibrated. As shown in FIG. 5A, some preferred embodiments include of method of calibrating a mobile device 230, which includes performing auto-leveling of the mobile device 570; placing the mobile device on a substantially flat surface 572; collecting a first set of accelerometer data of the mobile device 574; rotating the mobile device in a preferred direction 576; collecting a second set of accelerometer data of the mobile device 578; converting the first and second sets of accelerometer data to pitch calibrations and roll calibrations 580; computing an average for the pitch and roll calibrations 582; and saving the result on the mobile device 584.

Some preferred embodiments include systems and methods of accounting for a mobile device's case 515 and camera configurations 517. For example, as show in FIG. 5B and FIG. 5D, a mobile device 230 may have a protruding feature that prevents a mobile device 230 from lying flat on a surface. In such scenarios, a mobile device 230 may need to be calibrated with a pitch adjustment 520 and/or a roll adjustment 530 to complete the auto-leveling 540.

After auto-leveling 540 has been completed, mobile device 230 can be placed on a flat surface 510 to allow for accelerometer 110 to collect accelerometer data 550 of the mobile device 230.

An accelerometer 110 is a device that measures the acceleration of an object. It works using an electromechanical sensor designed to measure static acceleration, a constant force acting on a body. In this case the acceleration is due to the mass of the earth. It is predictable and uniform for any given location. However, there is a slight variation in this acceleration due to the oblateness of the earth, so the acceleration can be adjusted based upon the device's latitude. Computing gravitational acceleration based upon latitude includes the following:

$$g 45 = 9.806 ;$$

$$gPoles = 9.832 ;$$

$$gEquator = 9.78 ;$$

$$lat = ( deviceLatitude * PI ) / 180 ;$$

$$g = g 45 - 0.5 * ( gPoles - gEquator ) * cos ( 2 * lat ) .$$

Moving a device creates a dynamic acceleration (non-uniform). In this case, the acceleration change is sudden compared to its previous state. In preferred embodiments, a focus is placed on static acceleration, so whenever the mobile device 230 is moved (e.g., during setup or determining the target line) a moving average of 100 samples of accelerometer data is performed, in preferred embodiments. The initial accelerometer values might still be experiencing the effects of moving the device, so performing a moving average allows to mitigate the impacts of short-term fluctuations.

After a first set of accelerometer data 550 has been collected, preferred embodiments include rotating the mobile device 230 in order to collect another set of accelerometer data 550. For the most precise calibration, a rotation of 180 degrees from the starting point of the mobile device 230 is preferred.

However, as shown in FIGS. 5C and 5D, the most preferred embodiment includes four rotations of the mobile device 230, each rotation in a 90-degree increment. These preferred embodiments also include collecting a plurality of readings from each rotation, and then averaging the readings to collect pitch 520 and roll 530 values. As shown in FIG. 5D, when the four pitch and roll values are added together, the surface pitch Θ and surface roll ϕ cancel each other out: Θ+−Θ=0 and ϕ+−ϕ=0. All that remains are the error introduced by the phone case 515 and or camera lens 517. Therefore, averaging the four pitch and roll values automatically removes the slope of the surface being used, leaving only the average pitch and roll errors.

These Preferred embodiments include the following steps:
1. Perform one-time auto level step to accommodate any device case or camera lens configuration;
2. Place device on flat, level surface;
3. Start the setup process (begin collection of accelerometer data (x/y/z));
4. Collect 100 samples as a moving average, using final mean for (x/y/z) data point;
5. Prompt user to rotate device 90 degrees clockwise or counterclockwise;
6. Press continue button;
7. Repeat three times such that the four orthogonal directions in our plane have been recorded;
8. Convert the four (x/y/z) readings to pitch and roll (pitch=ϕ=Math.atan2(−y, sqrt(y*y+z*z))) (roll=θ=Math.atan2(x, −z));
9. Compute average for pitch and roll; and
10. Save the result.

Other preferred embodiments disclose a system for calibration that couple a mobile device 230, accelerometer 110, memory 560 and one or more processors 565. In preferred embodiments, the accelerometer 110, memory 560 and one or more processors 565 can all be located within the mobile device 230, such as a smart phone. Once the mobile device has auto-leveled 540, and the plurality of accelerometer data 550 has been collected, it can be saved on the smart phone so that a putting green can be properly read by the smart phone. If mobile device 230 is not properly calibrated, green reading data may be inaccurate and not helpful to a golfer.

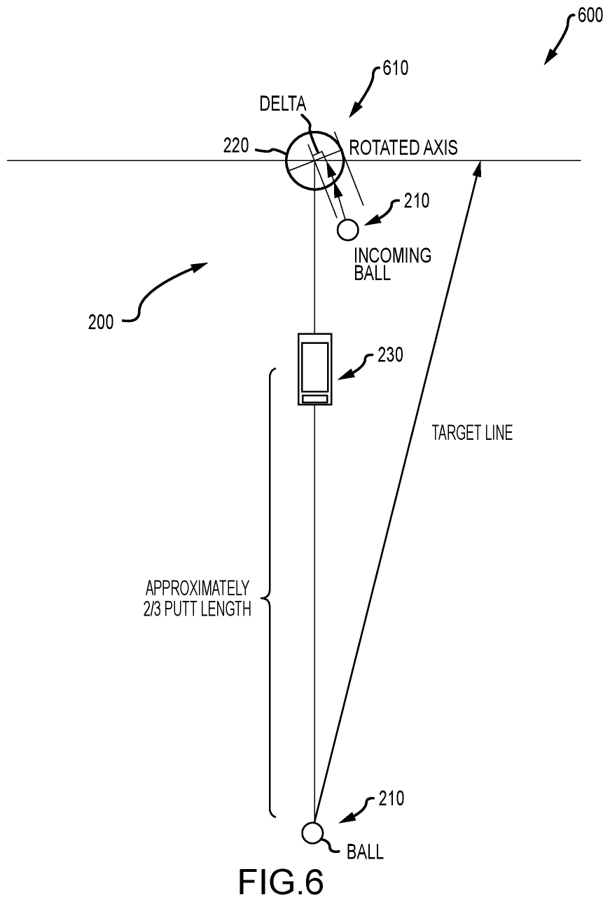

FIG. 6 is a schematic, diagrammatic representation of a putting green slope measurement process 600, in accordance with at least one embodiment of the present disclosure. The putting green slope measurement process 600 may for example involve:
1. Placing phone 230 on a flat surface and face-up in the correct position on the putting green 200, ⅔rds of the way between the ball 210 and the cup 220;
2. Recognizing that the putting green 200 is visibly a level or inclined plane;
3. Creating a global coordinate frame using axes 610 (e.g., North, East, Up), while a second set of axes mark the coordinate frame of the putting green surface (e.g., X, Y, Z); Angles θ1, θ2, and θ3 mark the difference between the global coordinate frame axes and the putting green surface axes; and
4. Calculating the target line 245.

Some preferred embodiments also include recognizing that the putting green 200 has grass blades with a particular height H and spacing P and accounting for these numerical values in slope measurement process 600.

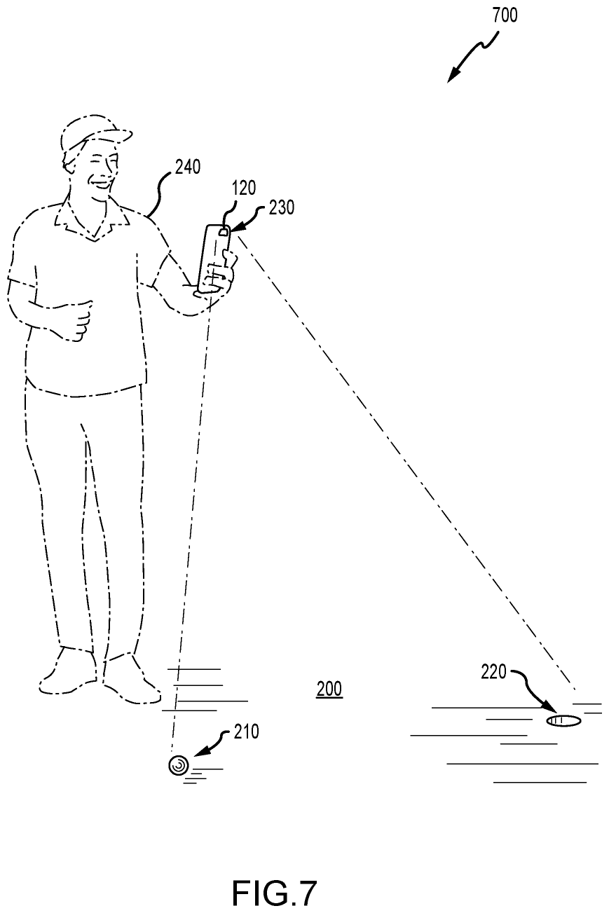

FIG. 7 is a schematic, diagrammatic representation of a putting green measurement process 700, in accordance with at least one embodiment of the present disclosure. The putting green measurement process 700 may for example involve a golfer 240 photographing the putting green 200 with the phone camera 120.

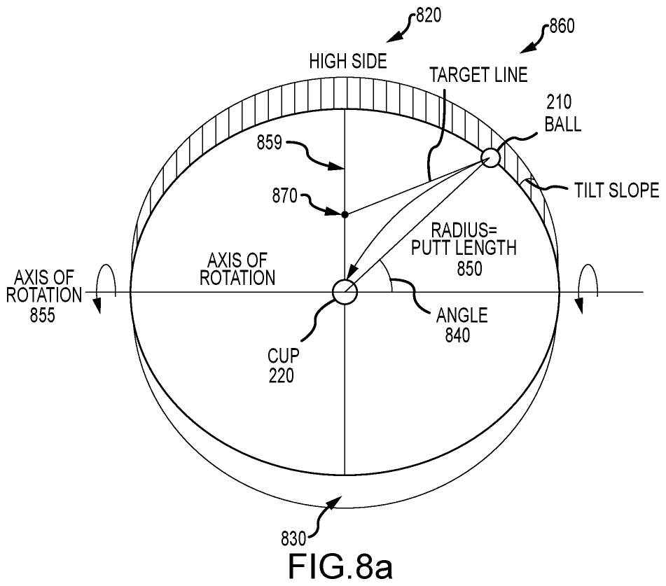

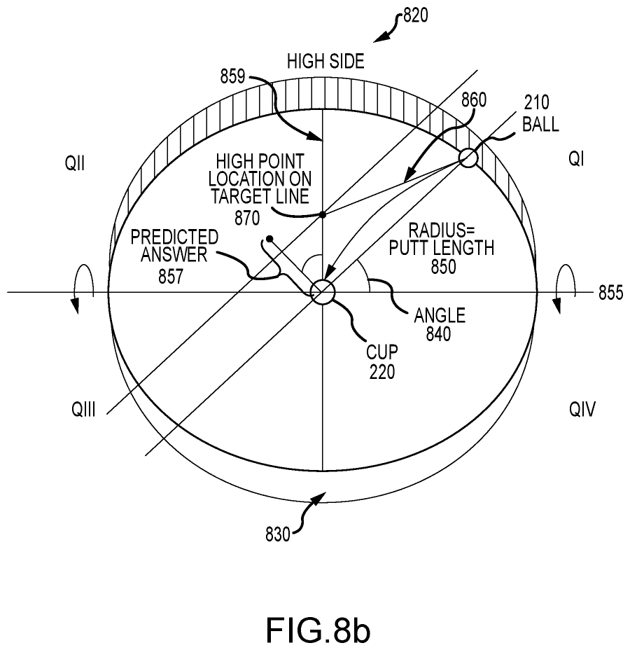

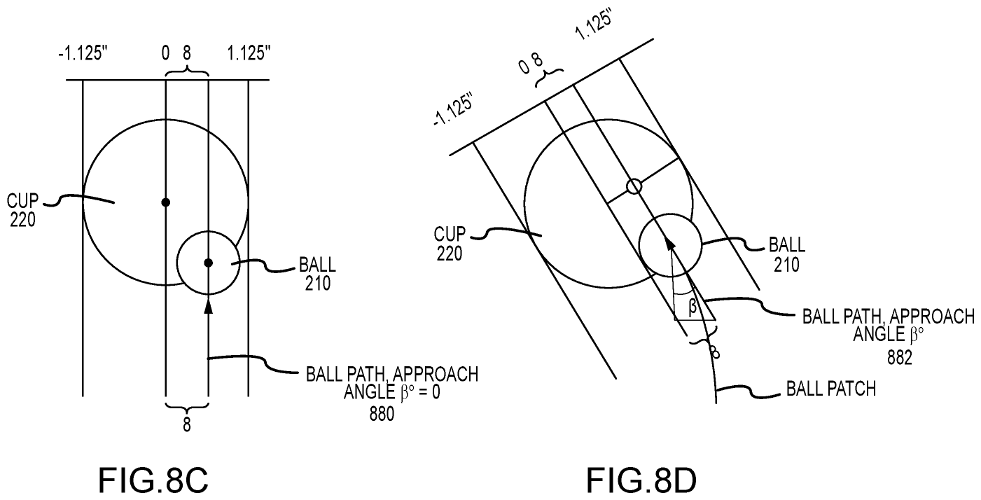

FIG. 8A is a diagrammatic representation of a golf ball 210 approaching a cup 220, in accordance with at least one embodiment of the present disclosure.

Accordingly, and similar as disclosed in FIGS. 1 and 2 above, user inputs include a friction coefficient user input/green speed 140, a putting distance user input (e.g., a distance between the ball and the cup), and a “targeted distance past the cup” user input 144 (collectively user input data 160).

In preferred embodiments, the golfer 240 then places the phone 230 approximately ⅔rds of the distance towards the cup 220 (see FIG. 6). Using the internal 3-axis accelerometer 110, inclinometer 112, gyroscope 114 (e.g., a 3-axis gyroscope), and/or magnetometer 116, a magnitude of break calibration 260 is calculated of the putting green 200, where the magnitude of break calibration 260 includes an averaged pitch 270 and roll 280 calculation of the putting green 200. The optimal initial velocity 292 of a putt is then determined. The user input data 160, the magnitude of break 260 and the initial velocity 290 are then combined at the processor to create green reading data 294. The green reading data 294 is used to create user output data 296 that is displayed to a golfer 240 on a user interface 130. In preferred embodiments, the user output data 296 comprises the optimal putting line 297 for a user on the golf putting green and an optimal putting stroke 298. The optimal putting stroke comprises a numerical deviation of a backswing of a golfer 299 based at least in part on the golfer's normal backswing and the green reading data 294.

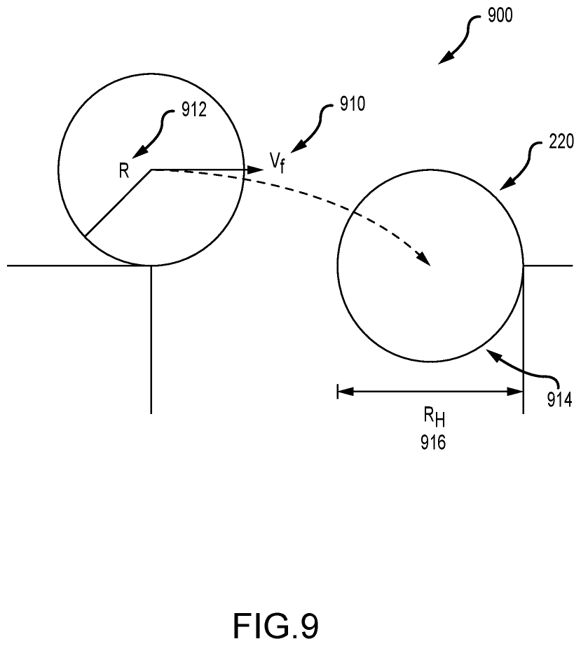

In preferred embodiments, as shown in FIG. 9, a critical velocity of the putt value is calculated through preferred embodiments 900. Critical velocity refers to the simplest condition for the capture of a golf ball that is traveling directly towards the center of the hole. This trajectory is for the golf ball 210, after it leaves the front rim at velocity v_{f} 910, to free fall a distance greater than its radius, R 912, before it strikes the far rim 914.

The time of the free-falling golf ball is given by the following equation:

$$t = \frac{( 2 {R}_{H} - R )}{{υ}_{f}}$$

Where R_{H} 916 is the radius of the cup (5.40 cm), R is the radius of the ball (2.135 cm), and v_{f} is the final velocity of the ball as it enters the cup.

In terms of v_{f}, the condition for capture by free fall is:

$${υ}_{f} < ( 2 {R}_{H} - R ) {( \frac{8}{2 R} )}^{1 / 2}$$

Putting on a level surface (pitch=0, roll=0) or across a tilted green with pitch=0, roll is non-zero.

$$0 < {υ}_{f} < 1.63 m / s$$

Putting straight uphill:

$$0 < {υ}_{f} < 1.71 m / s$$

Putting straight downhill:

$$0 < {υ}_{f} < 1.56 m / s$$

There is a dependence of the deceleration of a golf ball on its speed, with the retarding force increasing at lower speeds.

Critical velocity is an important feature in putting because there can be a sometimes-drastic break at the very end of a putt as it decelerates to a stop near the hole.¹ As a ball rolls across the green, it can experience a slightly larger deceleration, proportional to time, in rolling friction and is determined by the following equation: ¹This phenomenon is described in chapter 54, “Mechanical Interaction of the Golf Ball With Putting Greens.” by Mont Hubbard and LeRoy W. Always and can be found in the “Science and Golf III, Proceedings of the World Scientific Congress of Golf” (©1999. The World Scientific Congress of Golf Trust)

$${ρ}_{g} = initialRho + 0.00237 * t$$

This equation holds for a motion interval between 0 and 3.654 seconds. Therefore, the equation can be used for the entire duration of motion on putts that roll 3.654 seconds or less. However, in the case where the ball rolls for more than 3.654 seconds, a static value of rolling friction (0.6/stimp) of ρ_{g} for the initial roll of the putt (time_to_stop−3.654 seconds) can be used, then apply the additional friction at time=3.654. Using the new value of ρ_{g}, the acceleration using the previous equations must be recomputed.

For example, in some preferred embodiments, a method of calculating a true putting line using critical velocity calculations is provided, that method comprising:
1. If the ball does not reach the desired length minus 2 inches, bump the initial velocity by 0.001 m/s and try again, starting on a target line directly at the cup.
2. If the ball's ending location is greater than the desired length putt+2 inches, reset the velocity to the initial speed and move the target line 0.1 inch up the fall line.
3. If the ball reaches the hole at the velocity needed to stop the ball at the desired distance past the cup +/− two inches, loop through the computed (x, y) points to determine if the ball crosses the edge of the cup. Note that the radius of a golf cup is 2.125 inches.
4. Using the angle of the approaching ball and its velocity, determine if the ball will be captured by the hole.
5. Compute the angle of the incoming ball: betaPrime=atan (velₓ/vel_{y})
6. Determine the ball's entry line on a rotated axis and compute the ball offset (delta) from the center of the cup.

In these preferred embodiments, identifying the high side of the cup (aka the fall line) is a critical step in predicting how a ball will break. To find the high side mathematically, it is first necessary to define a frame of reference.

Consider a planar surface that can be tilted forward and backward (pitch) and side to side (roll). Place a circle on the green centered at the hole with radius equal to the putt length.

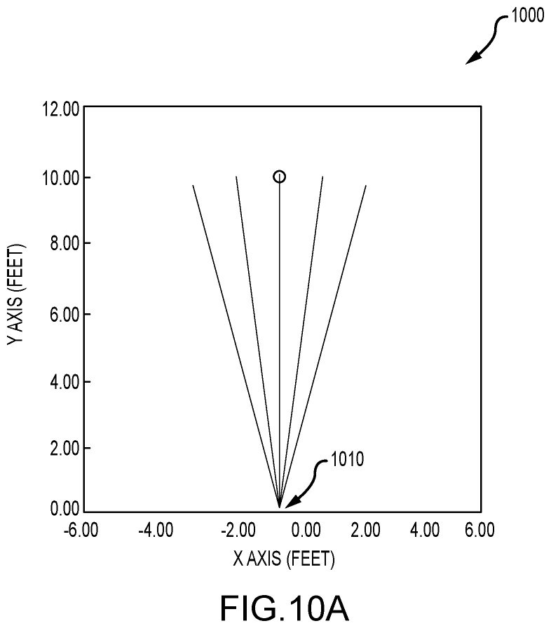

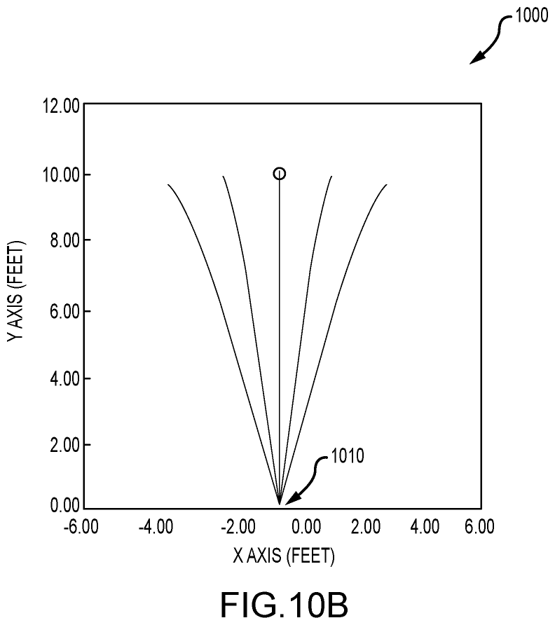

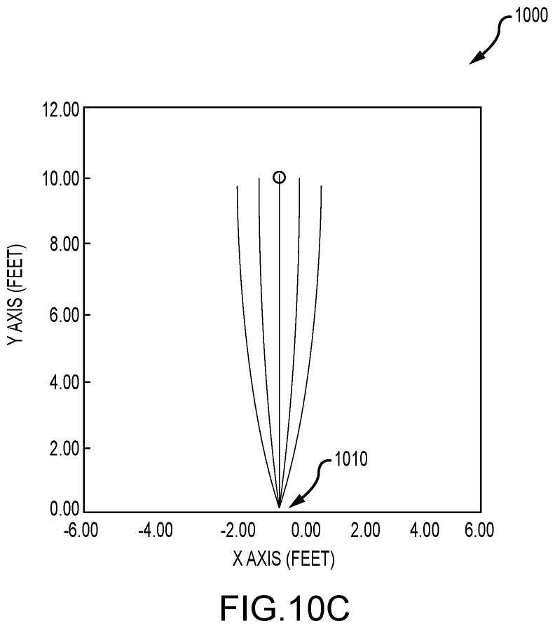

In preferred embodiments, as shown in FIGS. 10A-C, the origin of the frame of reference 1000 is the golf ball, x=0, y=0 or (0, 0) 1010. In these preferred embodiments, the line connecting the ball 210 and the cup 220 is the y-axis. The cup 220 is located at x=0, y=putt length, or (0, putt length).

The ball 210 can also be viewed as sitting on the circumference of a circle with the center located at the cup 220 (see FIGS. 8A and 8B). The frame of reference is chosen such that the high side of the hole 820 is at the twelve o'clock position. Similarly, the low side of the hole 830 is at six o'clock. The ball rests on the circumference of this circle and can be described by the angle 840 it creates as determined by the pitch and roll of the device: angle=tan2(−pitch,−roll), where −180 degrees<=angle<=180 degrees. Note that the minus signs are due to the fact that a device's viewing area considers the top of the screen to be y=0 and gets larger as one progresses down the view screen. Also, note that every putt is uniquely described by its pitch, roll, and length. Every initial ball location can be expressed within this frame of reference by knowing the putt length 850 (aka radius of circle) and ball's angle 840 relative to the green's axis of rotation 855 (see FIG. 8A).

Once the target line 860 has been determined, the high side of the hole 820 can be found. Recall that we defined our frame of reference such that the high side 820 is at the twelve o'clock position (see FIG. 8C). To locate the high side 820, rotate the predicted answer 857 such that it aligns with the vertical axis 859. Then find the intersection of the target line 860 and the rotated point 870. In the following code snippet,

```
/ / Q I
if (ang >= 0 && ang < Math.PI / 2)
  primes = rotateAroundAxisZ(cAP, 0, angle);
/ / Q II
if (ang >= Math.PI / 2 && ang < Math.PI)
  primes = rotateAroundAxisZ(cAP, 0, Math.PI − angle);
/ / Q III
if (ang >= −Math.PI && ang < − Math.PI / 2)
  primes = rotateAroundAxisZ(cAP, 0, Math.abs(angle) − Math.PI);
/ / Q IV
if (ang >= −Math.PI / 2 && ang < 0)
  primes = rotateAroundAxisZ(cAP, 0, Math.abs(angle));
highPointX = puttLengthInches / (puttLengthInches / cAP − primes[1] /
    primes[0])
highPointY = (primes[1] / primes[0]) * highPointX + puttLengthInches
highPoint = [highPointX, highPointY]
```

The critical ball-capture velocity is determined by the following equation:

$$vCritical = 1.63 - 1.63 * {( δ / holeRadius )}^{2} ,$$

where δ is defined as the impact parameter, a number between zero and the cup radius. This number represents the absolute value of the distance, left or right, of the centerline of the hole relative to the angle of entry (see FIGS. 8C and 8D).

A ball entering the cup directly straight in the center (δ equals zero) 880 has a critical velocity of 1.63 mps, as showing in FIG. 8C. However, a ball approaching the cup on the edge 882 (δ equals holeRadius) yields a critical velocity of zero, meaning the ball will not enter the cup. For values very nearly equal to holeRadius, certain velocities will yield a lip out.

When the ball 210 does not roll directly into the cup 220, the approach angle must be determined so as to determine the impact parameter, as shown in FIG. 8D.

Knowing the velocity of the incoming ball and the angle it approaches the hole allows for determining whether or not the ball will be captured by the hole. Any ball traveling faster than the adjusted critical velocity will not be captured.

In preferred embodiments, this is calculated by the following steps:
1. Compute the critical velocity in the roll and pitch dimensions using the approach angle (betaPrime) computed earlier.
2. Compute Pitch—uphill/downhill: v_f_psi=(1/Math.sqrt(1−Math.cos(betaPrime)*Math.sin(pitch)))*vCritical
3. Compute Roll—side to side: v_f_theta=(1/Math.sqrt(1+Math.sin(betaPrime)*Math.sin(roll)))*vCritical
4. If the overall velocity as the ball crosses the edge of the cup is less than the critical speeds in both the pitch and roll dimensions, then the ball is considered to be holed.

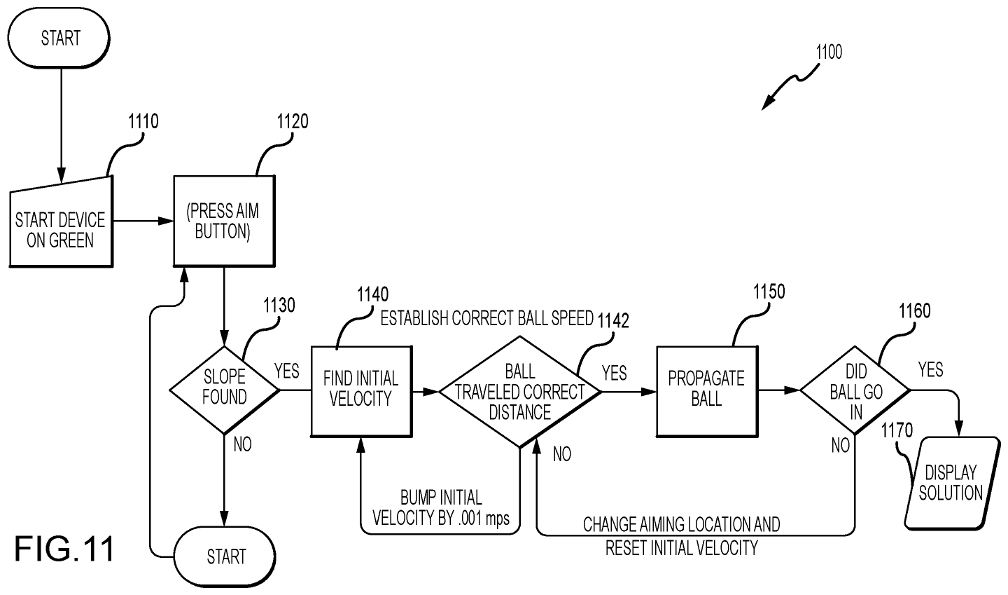

FIG. 11 shows a flow diagram of an example putting parameter determination method 1100, in accordance with at least one embodiment of the present disclosure.

It is understood that the steps of method 1100 may be performed in a different order than shown in FIG. 11, additional steps can be provided before, during, and after the steps, and/or some of the steps described can be replaced or eliminated in other embodiments. One or more of steps of the method 1100 can be carried by one or more devices and/or systems described herein, such as components of the putting parameter determination system 100, processor 150, mobile device 250, and/or processor circuit 1250.

In step 1110, the method includes placing a mobile device on a putting green 1110. Execution then proceeds to step 1120, wherein an aim button is pressed by a user. In step 1130, a slope is determined of the putting green. If the slope is properly determined, execution proceed to step 1140, wherein a correct ball speed is determined. If the slope is not properly determined, step 1130 is repeated. In step 1140, the mobile device makes an initial determination for an initial velocity of the ball. If the ball travels the correct distance 1142, execution proceeds to step 1150, wherein the ball is propagated. If the ball does not travel the proper distance, the velocity is bumped up by 0.001 mps. The velocity continues to increase by 0.001 mps until the ball travels the correct distance. In step 1160, after the ball is propagated, it is determined whether the ball has been holed. If so, execution proceeds to step 1170, wherein the solution is displayed to a user on the mobile device. If the ball is not holed, execution goes back to recalculate the aiming location and the initial velocity.

It is noted that flow diagrams are provided herein for exemplary purposes; a person of ordinary skill in the art will recognize myriad variations that nonetheless fall within the scope of the present disclosure. For example, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, in order to avoid latency issues noticeable to the user, the putting parameter determination system may need to calculate the optimal putting line and putting stroke within one second of the mobile device being placed face-up on the putting green.

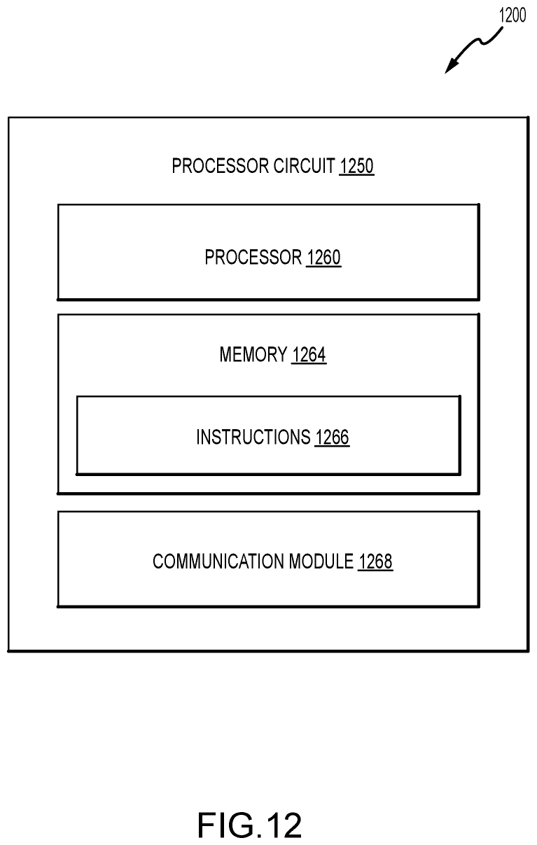

FIG. 12 is a schematic diagram of a processor circuit 1250, according to embodiments of the present disclosure 1200. The processor circuit 1250 may be implemented in the system 100, or other devices or workstations (e.g., third-party workstations, network routers, etc.), or on a cloud processor or other remote processing unit, as necessary to implement the method. As shown, the processor circuit 1250 may include a processor 1260, a memory 1264, and a communication module 1268. These elements may be in direct or indirect communication with each other, for example via one or more buses.

The processor 1260 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1260 may also comprise another hardware device, a firmware device, or any combination thereof configured to perform the operations described herein. The processor 1260 may also be implemented as a combination of computing devices, e.g., a combination of a DSP and a microprocessor, a plurality of microprocessors, one or more microprocessors in conjunction with a DSP core, or any other such configuration.

The memory 1264 may include a cache memory (e.g., a cache memory of the processor 1260), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1264 includes a non-transitory computer-readable medium. The memory 1264 may store instructions 1266. The instructions 1266 may include instructions that, when executed by the processor 1260, cause the processor 1260 to perform the operations described herein. Instructions 1266 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1268 can include any electronic circuitry and/or logic circuitry to facilitate direct or indirect communication of data between the processor circuit 1250, and other processors or devices. In that regard, the communication module 1268 can be an input/output (I/O) device. In some instances, the communication module 1268 facilitates direct or indirect communication between various elements of the processor circuit 1250 and/or the system 100. The communication module 1268 may communicate within the processor circuit 1250 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Acronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or readings from the device) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the putting parameter determination system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the putting parameter determination system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A method of calibrating a mobile device for reading a putting green, comprising:
performing auto-leveling of the mobile device;
placing the mobile device on a substantially flat surface;
collecting a first set of accelerometer data of the mobile device;
rotating the mobile device in a preferred direction;
collecting a second set of accelerometer data of the mobile device;
converting the first and second sets of accelerometer data to pitch calibrations and roll calibrations;
computing an average for the pitch and roll calibrations; and
saving the result on the mobile device.

2. The method of claim 1, wherein the auto-leveling of the mobile device accommodates for a mobile device case configuration.

3. The method of claim 2, wherein the auto-leveling of the mobile device accommodates for a configuration of one or more cameras protruding from the mobile device.

4. The method of claim 3, wherein the auto-leveling of the mobile device comprises a pitch adjustment and a roll adjustment caused by the mobile device case configuration or the one or more cameras protruding from the mobile device.

5. The method of claim 1, wherein the rotating of the mobile device is substantially 180 degrees from where the mobile device was first placed on the substantially flat surface.

6. The method of claim 1, wherein the first set of accelerometer data comprises an average collected from a plurality of accelerometer readings.

7. The method of claim 5, wherein the plurality of accelerometer readings comprises at least 100 accelerometer readings.

8. The method of claim 1, wherein the second set of accelerometer data comprises an average collected from a plurality of accelerometer readings.

9. The method of claim 7, wherein the plurality of accelerometer readings comprises at least 100 accelerometer readings.

10. The method of claim 1, wherein the accelerometer data is collected by an accelerometer inside the mobile device.

11. A system, comprising:
a mobile device, wherein the mobile device is placed on a substantially flat surface and wherein the mobile device is rotated in a preferred direction after a period of time;
an accelerometer;
a memory; and
one or more processors operatively coupled to the mobile device, the accelerometer and the memory, the processors being configured to execute operations that, when executed, cause the processors to perform operations, the operations, comprising:
performing auto-leveling of the mobile device;
collecting a first set of accelerometer data of the mobile device;
collecting a second set of accelerometer data of the mobile device;
converting the first and second sets of accelerometer data to pitch calibrations and roll calibrations;
computing an average for the pitch and roll calibrations; and
saving the result on the mobile device.

12. The system of claim 11, wherein the auto-leveling of the mobile device comprises a pitch adjustment and a roll adjustment.

13. The system of claim 11, wherein the first set of accelerometer data comprises an average collected from a plurality of accelerometer readings.

14. The system of claim 13, wherein the plurality of accelerometer readings comprises at least 100 accelerometer readings.

15. The system of claim 13, wherein the second set of accelerometer data comprises an average collected from a plurality of accelerometer readings.

16. The system of claim 15, wherein the plurality of accelerometer readings comprises at least 100 accelerometer readings.

17. The system of claim 11, wherein the accelerometer data is collected by an accelerometer inside the mobile device.

18. A method of calibrating a mobile device for reading a putting green, comprising:
performing auto-leveling of the mobile device;
placing the mobile device on a substantially flat surface;
collecting a first set of accelerometer data of the mobile device;
rotating the mobile device substantially 90 degrees in a preferred direction;
collecting a second set of accelerometer data of the mobile device;
rotating the mobile device substantially 90 degrees in the preferred direction;
collecting a third set of accelerometer data of the mobile device;
rotating the mobile device substantially 90 degrees in the preferred direction;
collecting a fourth set of accelerometer data of the mobile device;
converting the first, second, third and fourth sets of accelerometer data to pitch calibrations and roll calibrations;
computing an average for the pitch and roll calibrations; and
saving the result on the mobile device.

19. The method of claim 18, wherein the auto-leveling of the mobile device accommodates for a mobile device case configuration and one or more cameras protruding from the mobile device.

20. The method of claim 19, wherein the auto-leveling of the mobile device comprises a pitch adjustment and a roll adjustment caused by the mobile device case configuration or the one or more cameras protruding from the mobile device.
